(19) United States
(12) Patent Application Publication
(10) Pub. No.: US 2009/0015214 A1
(43) Pub. Date: Jan. 15, 2009

(54) Power factor correction method and device

(76) Inventor: Hung-Chi Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,398

(22) Filed: Nov. 2, 2007

(30) Foreign Application Priority Data
Jul. 9, 2007 (TW) 96133405

(51) Int. Cl. G05F 1/70

(52) U.S. Cl. 323/205

(57) ABSTRACT

A power factor correction method and the controller thereof, applied to a boost-type converter, are provided. First, the power factor correction method uses the input and output voltages to generate a reference switching signal. Next, a voltage control circuit uses the difference between the output voltage and a voltage command to get a duty phase. Then, the switching control signal is determined by shifting the phase of the reference switching signal according to the duty phase. Finally, a comparator compares the switching control signal with a triangle waveform signal to determine the switching signal. A power factor controller, which utilizes this method, uses only a single voltage control circuit to get the switching signal to regulate the output voltage and shape the current waveform without sensing current and a current control circuit, so that the complexity of the invented control circuit for the power factor correction is reduced dramatically.

### FIELD OF THE INVENTION

This invention relates to a power factor correction method and device, and, more especially, to a current senserless power factor correction method and device.

### BACKGROUND OF THE RELATED ART

The power factor correction is a technology of modulating the duty ratio of the main switch to control the conduction time, and therefore the input current waveform will be shaped automatically to follow the input voltage waveform to raise the power factor of a boost-type converter. The averaged duty ratio d̅ is defined as d̅=Tₒₙ/Tₛ, where the Tₒₙ and Tₛ are the conduction time and the switching period of the main switch, respectively.

First, the main electrical circuit of a boost-type converter is illustrated as following and the circuit diagram is shown as FIG. 1. The boost-type converter uses a rectifier 200 to connect an external power source 100, which provides a voltage Vₛ. Another side of the rectifier 200 connects an inductor L, a diode D and a capacitor C_{d} to provide the load 300 with voltage [symbol] . The inductor L connects to a main switch S, which is controlled by a power factor controller 400. In general, the main switch S is implemented by a metal oxide silicon field effect transistor (MOSFET), so the main switch is named transistor switch M also.

When the main switch S is turned on, the power source 100, the rectifier 200 and the inductor L can be seen as an independent loop. Since the voltage of the power source 100 is rectified by the rectifier 200, the voltage V_{L} on the inductor L is always positive. Therefore, the current I_{L} through the inductor L rises up. Hereafter, the current I_{L} is called inductor current and the voltage V_{L} is called inductor voltage.

When the main switch S is turned off, the power source 100, the rectifier 200, the inductor L and the load 300 become one loop. The inductor voltage V_{L} will turn to negative, so that the inductor current I_{L} declines.

In convention, the power factor controller of the circuit is classified into two main modes, voltage-control mode and current-control mode. A conventional voltage-control mode power factor controller 400 is shown in FIG. 2. The power factor controller 400 uses a voltage circuit 10 to receive the output voltage [symbol] and a voltage command Vᵣ to generate a switching control signal V_{cont}. A comparator 11 compares the switching control signal V_{cont} with a triangle waveform signal Vₜᵣᵢ to determine the switching signal d(t), which is marked as d in figures.

The switching control signal V_{cont}, the triangle waveform signal Vₜᵣᵢ, the switching signal d(t) and the inductor current I_{L} are shown in the time chart diagram in FIG. 3. This kind of power factor controller only detects the output voltage [symbol] to shape the input current waveform, and is often operating with the discontinuous conduction mode (DCM).

The switching control signal V_{cont} is input to the noninverting end of a comparator. Comparing the switching control signal V_{cont} with the fixed triangle waveform signal Vₜᵣᵢ will obtain the switching signal d(t) with near constant duty ratio. When the switching signal d(t) is HIGH during the conduction time Tₒₙ, the switch transistor M is turned on, and the inductor voltage V_{L} is positive and is equal to the rectified input voltage. Therefore, although the duty ratio is near constant in voltage-control mode, the inductor current rising rate varies from switching period to switching period. As the result, the peak of the inductor current I_{L} will rise up as the input voltage increases. When the switching signal d(t) is LOW during the turning-off time T_{off}, the switch transistor M is turning off and the inductor voltage V_{L} is negative and is equal to the voltage difference between the output voltage and the input voltage. The input current I_{L} is shaped as a series of triangle waves shown in FIG. 3. This kind of power factor controller is simple with limited current shaping performance.

A current-control mode power factor controller is shown in FIG. 4. The current-control mode power factor controller is a double-circuit controller, which includes two control circuits, an external voltage control circuit 20 and an internal current control circuit 22. The external voltage control circuit 20 receives the output voltage [symbol] and a voltage command Vᵣ, and generates a current amplitude command Iᵣ according to the difference between the output voltage [symbol] and the voltage command Vᵣ.

A reference current generator 23 retrieves the reference signal S(ωt) of the input voltage Vₛ. A multiplier 24 produces a current command I_{L,r} from multiplying the current amplitude command Iᵣ by the reference signal S(ωt). Then, the internal current control circuit 22 receives the current command I_{L,r} and the inductor current I_{L} to determine the switching control signal V_{cont} in order to shape the input current to follow the input voltage waveform. Finally, the comparator 21 compares the switching control signal V_{cont} with the triangle waveform signal Vₜᵣᵢ generated by a wave generator 25, to determine the switching signal d(t), and the switching signal d(t) will be used to turn on and turn off the switch in order to shape the input current waveform.

The FIG. 5 shows the time chart of switching signal d(t), switching control signal V_{cont} and the inductor current I_{L}.

As shown in FIG. 5, the switching control signal V_{cont} is generated from the internal current control circuit 22 in FIG. 4. When the switching control signal V_{cont} is larger than the triangle waveform signal Vₜᵣᵢ, the switching signal d(t) is HIGH and the transistor M is turned on during the conduction time Tₒₙ. In the meanwhile, positive inductor voltage V_{L} contributes to the increase of the inductor current I_{L}. When switching control signal V_{cont} becomes smaller than the triangle waveform signal Vₜᵣᵢ, the switching signal d(t) will turn to LOW and the transistor M is turned off. During the period, the negative inductor voltage V_{L} results in the decrease of the inductor current I_{L}. Therefore, it follows that the resultant inductor current I_{L} would track closely the reference inductor current I_{L,r}.

The current-control mode controller needs to receive three input parameters—the output voltage [symbol] , the input voltage Vₛ and the inductor current I_{L}, and is implemented by multiple-circuit design such that the circuit design becomes more complex. The ripple in the output voltage [symbol] may distort the current command I_{L,r} through the voltage control circuit. As a result, the performance of current shaping and power factor correcting will become worse. Furthermore, it needs specific sampling strategy to avoid sampling current at the instant of switching.

Accordingly, for a power factor controller and correction method, how to simplify the circuit and improve the performance of the controller is still an important topic.

### SUMMARY OF THE INVENTION

It is an object of this invention to provide a power factor correction method and device. The power factor controller only uses a voltage control circuit and detects only the input voltage Vₛ and output voltage [symbol] without sensing any current. In addition, the invented power factor correction device is operating in continuous conduction mode (CCM).

For achieving the above object, an embodiment of this invention is implemented by a power factor correction method. The method includes steps of producing a duty phase according to the output voltage and a voltage command, producing a reference switching signal according to the input voltage and the output voltage, producing a switching control signal V_{cont} by shifting the reference switching signal according to the duty phase, and producing a switching signal by comparing the switching control signal with a triangle waveform signal.

For achieving the above object, an embodiment of this invention is implemented by a power factor controller. The controller includes a voltage control circuit, a reference signal generator, a duty phase shifter and a comparator. The voltage control circuit receives the voltage command and the output voltage of the converter to produce a duty phase, and the reference signal generator generates a reference switching signal, and the duty phase shifter shifts the reference switching signal to produce a switching control signal, and the comparator produces the switching signal.

### BRIEF DESCRIPTION OF THE DRAWINGS

FIG. 1 shows the main circuit diagram of a conventional boost-type converter.

FIG. 2 shows a circuit diagram of a voltage-control mode power factor controller according to a prior art.

FIG. 3 shows the time chart of the switching control signal V_{cont}, the switching signal d(t) and the inductor current I_{L} in a half line cycle according to the embodiment shown in FIG. 2.

FIG. 4 shows a circuit diagram of a current-control mode power factor controller according to a prior art.

FIG. 5 shows the time chart of the switching control signal V_{cont}, the switching signal d(t), the reference inductor current I_{L,r} and the inductor current I_{L} in a half line cycle according to the embodiment shown in FIG. 4.

FIG. 6 shows a flow chart of implementing the power factor correction method according to an embodiment of this invention.

FIG. 7, FIG. 8 and FIG. 9 show the different power factor controllers corresponding to the different embodiments of this invention respectively.

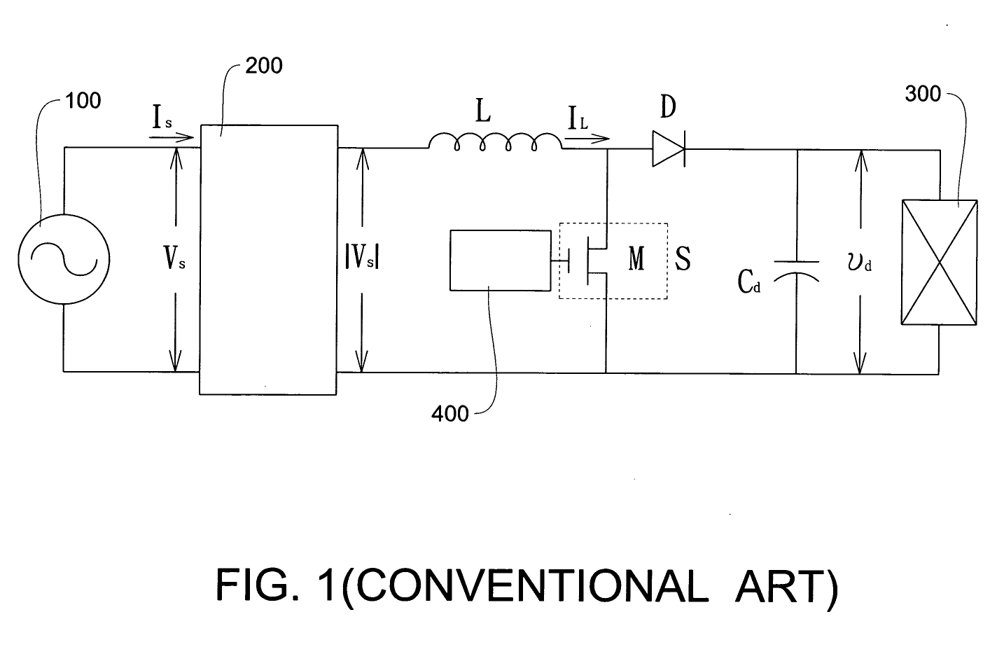

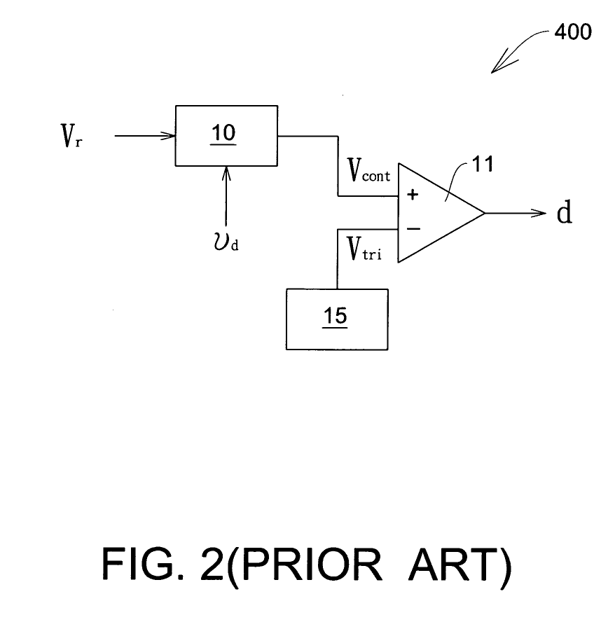

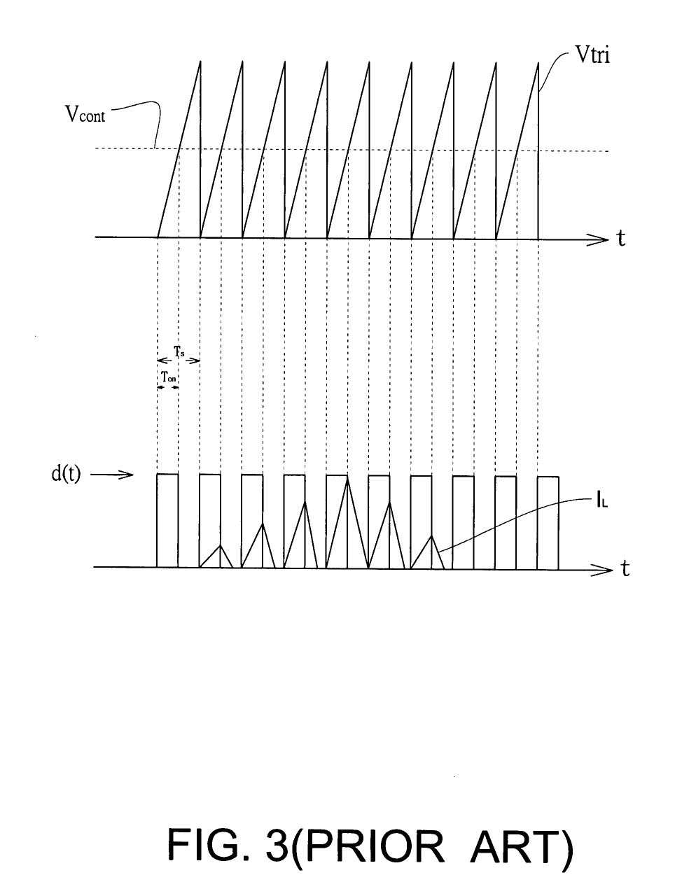

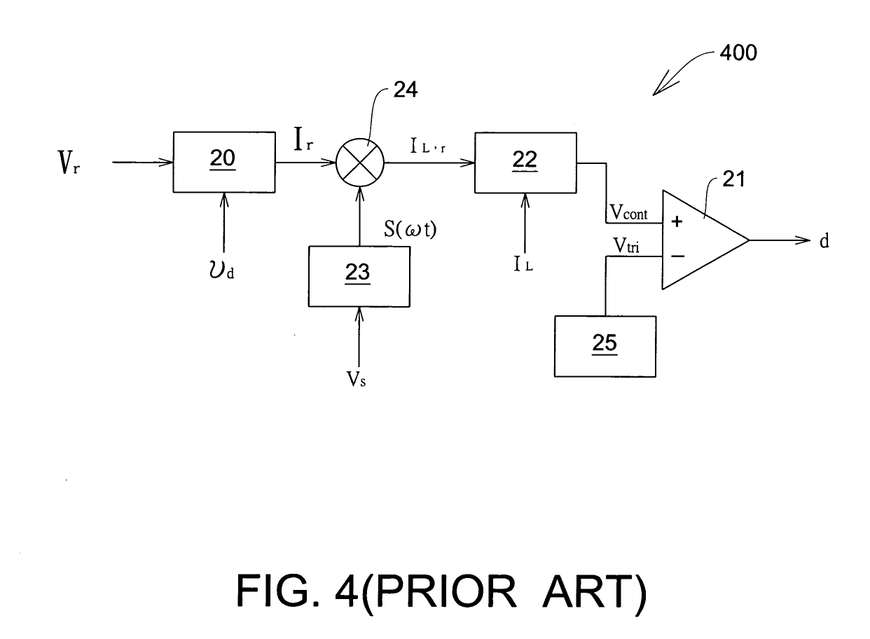

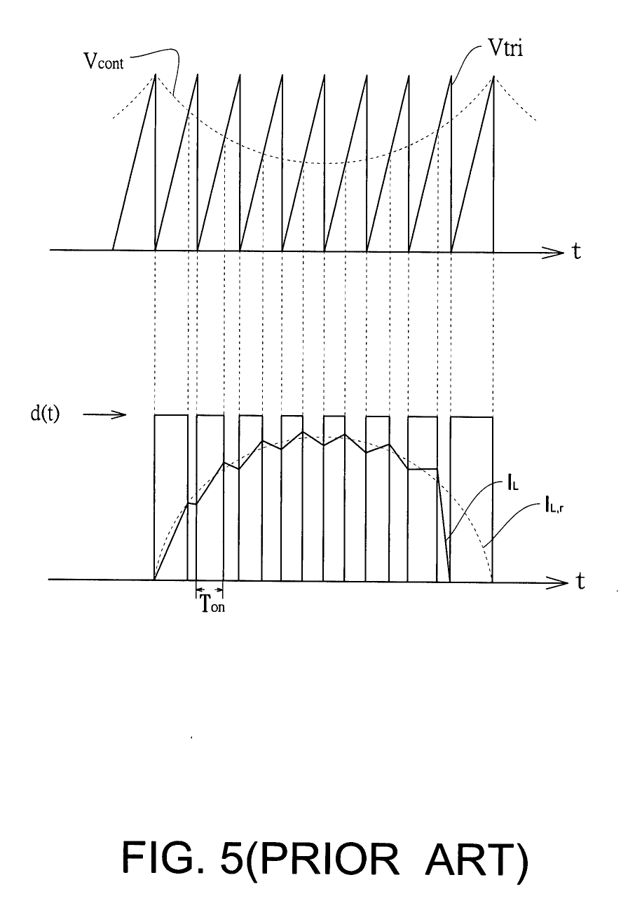

### DETAILED DESCRIPTION OF THE INVENTION

The beginning sections will introduce the theory of the phase controlled power factor correction according to this invention. It is assumed that the input voltage wave Vₛ is a sine wave \hat{V}_{S} sin(ωt). Then, average duty ratio d̅ within each switching cycle is defined as

$$\overline{d} = 1 - \frac{\hat{{V}_{s}}}{{V}_{d}} \vert sin ( ω t - θ ) \vert ,$$

wherein \hat{V}ₛ is the amplitude of the input voltage, V_{d} is the average output voltage in a switching period, ω is the angular frequency of the input voltage Vₛ, θ is the controllable duty phase, and t represents time. The inductor voltage V_{L} can be formulated as

$${V}_{L} = L \frac{d {I}_{L}}{d t} = \hat{{V}_{s}} \vert sin ( ω t ) \vert - \hat{{V}_{s}} \vert sin ( ω t - θ ) \vert ,$$

wherein the L represents the inductance of the inductor in the boost-type converter. In general, the duty phase θ is very small such that the above formula can be simplified by applying simple formula of sin θ≈θ and cos θ=1. Then, the above formula can be simplified to

$$\frac{d {I}_{L}}{d t} = \frac{\hat{{V}_{s}} θ}{L} \vert cos ( ω t ) \vert$$

to obtain

$${I}_{L} = \frac{\hat{{V}_{s}} θ}{ω L} \vert sin ( ω t ) \vert = {\hat{I}}_{s} \vert sin ( ω t ) \vert ,$$

wherein Îₛ is the amplitude of the input current. Therefore, form the circuit topology of boost-type converter, the input current Iₛ becomes Iₛ=Îₛ sin(ωt). Obviously, input current Iₛ possesses the same function as the input voltage, and its amplitude Îₛ can be directly controlled by adjusting the duty phase θ.

Let a specific value of the output voltage be the voltage command Vᵣ. According to the difference between the voltage command Vᵣ and the output voltage [symbol] , the duty phase θ can be obtained through the voltage control circuit. The following description of embodiments accompanying the drawings illustrates the spirit of this invention.

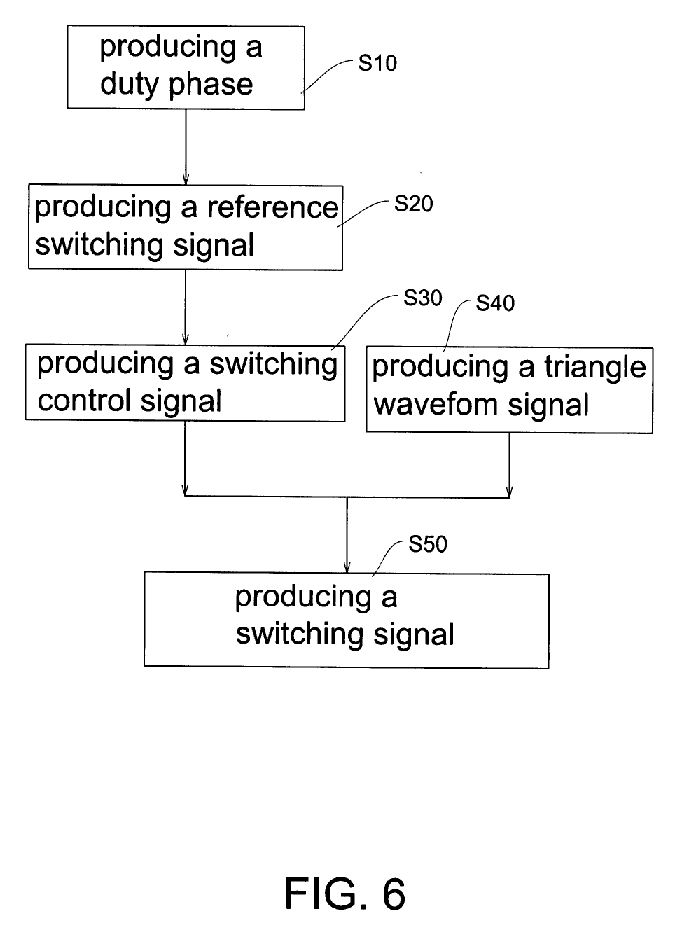

Refer to FIG. 6, which represents the process of producing switching signal d(t) for a phase controlled boost-type converter. As shown in figure, in step S10, it will produce a duty phase θ according to the output voltage [symbol] and voltage command Vᵣ. In step S20, it will produce a reference switching control signal according to the output voltage [symbol] and voltage Vₛ. In step S30, it will produce a switching control signal V_{cont} by shifting the reference switching signal with the duty phase θ. Meanwhile, in step S40, a triangle waveform signal Vₜᵣᵢ is produced by a triangular waveform generator. In step S50, it will produce a switching signal d(t) by comparing the triangle waveform signal Vₜᵣᵢ with the switching control signal V_{cont}. This embodiment is only used to explain this invention but not limit this invention, and it is important that the steps S10, S20 and S30 are not necessary to be proceeded in a specific order, and they can be done in different order.

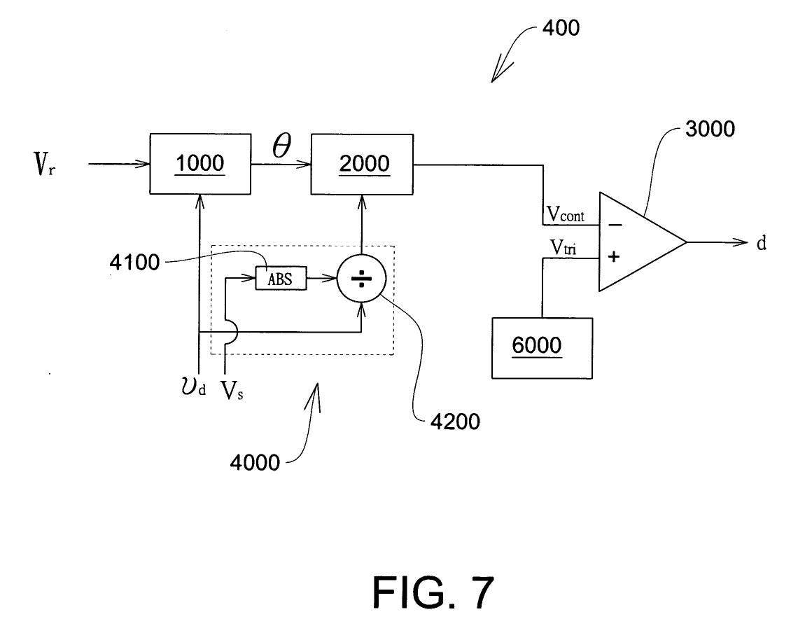

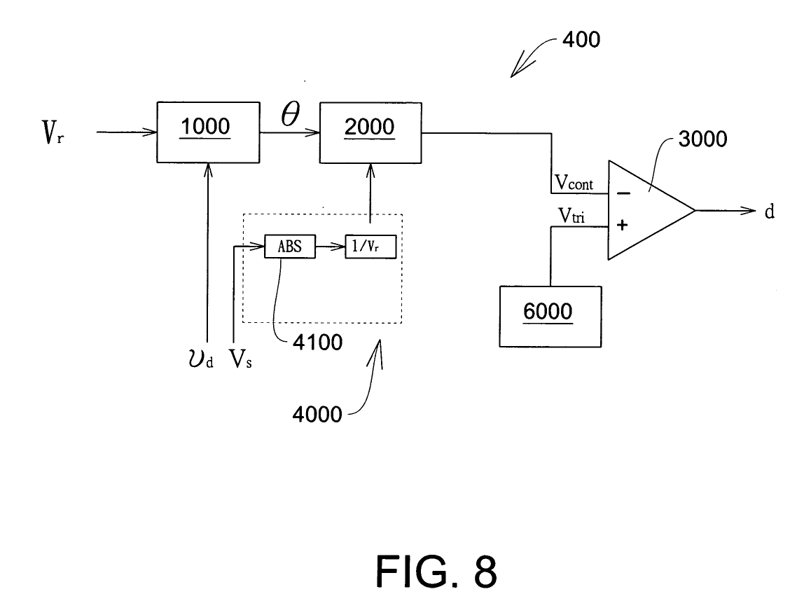

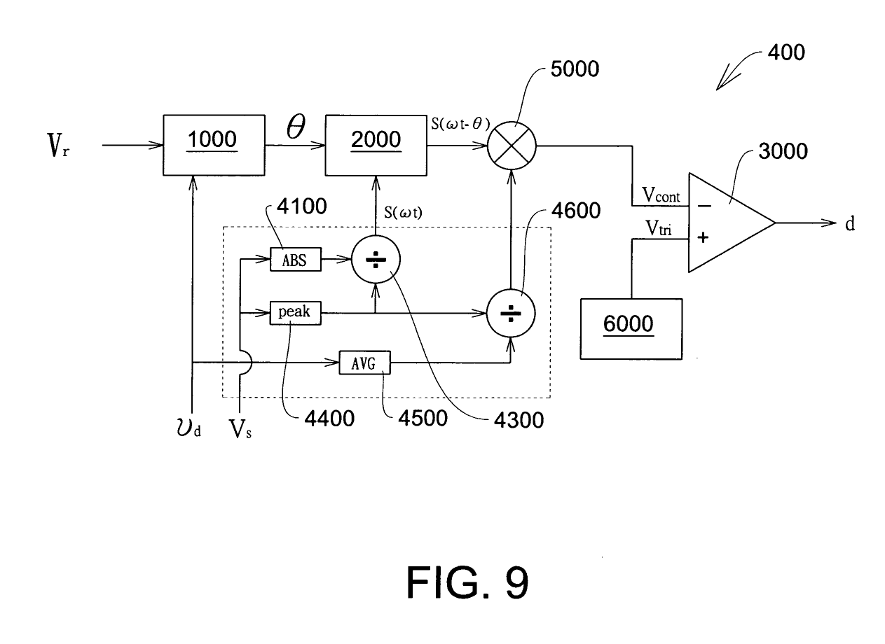

The FIG. 7, FIG. 8 and FIG. 9 show the various power factor controllers according to various embodiments of this invention.

FIG. 7 shows a power factor controller according to a first exemplary embodiment. The voltage circuit 1000 receives voltage command Vᵣ and output voltage [symbol] of the converter to produce a duty phase θ. The reference switching signal generator 4000 receives input voltage Vₛ and the output voltage [symbol] to produce a reference control switching signal |V_{S}|/ [symbol] . First, an absolute value retriever 4100 (rectifier) is used to obtain an absolute value of input voltage |V_{S}|, and then a divider 4200 is used to obtain the reference switching signal |V_{S}|/ [symbol] . The reference switching control signal |V_{S}|/ [symbol] is sent to a phase shifter 2000, which is able to shift the reference switching control signal |V_{S}|/ [symbol] with the duty phase θ to produce a switching control signal V_{cont}. The switching control signal V_{cont} is sent to the inverting end of a comparator 3000. A triangle waveform signal Vₜᵣᵢ, generated by a triangle wave generator 6000 is sent to the noninverting end of the comparator 3000. The comparator 3000 compares the switching control signal V_{cont} and the triangle waveform signal Vₜᵣᵢ to produce a switching signal d(t). In general, the variation in the output voltage [symbol] is very small due to bulk output capacitor, such that the output voltage [symbol] can be replaced by the average output voltage V_{d}.

FIG. 8 shows a power factor controller according to the second exemplary embodiment. Due to the well-design voltage control circuit, the average output voltage V_{d} is well regulated to the voltage command Vᵣ. Therefore, the voltage command Vᵣ can be used to replace average output voltage V_{d}. Thus, by comparing this embodiment with that in FIG. 7, the divider 4200 of the reference switching signal generator 4000 can be replaced with a simple amplifier 1/Vᵣ to reduce the complexity of the controller circuit as shown in FIG. 8.

FIG. 9 shows a power factor controller according a third exemplary embodiment. The difference between this embodiment and above two embodiments is the design of the reference switching signal generator 4000. In this embodiment, the reference switching signal generator 4000 uses an absolute value retriever 4100 (rectifier) to obtain the absolute value of the input voltage |V_{S}|, a maximum retriever 4400 to obtain the amplitude of the input voltage \hat{V}_{S}, a first divider 4300 to calculate a reference signal S(ωt), an average retriever 4500 to calculate the average voltage V_{d} of the output voltage [symbol] , and an second divider 4600 to obtain the amplitude of the switching signal \hat{V}_{S}/V_{d}. The switching period average voltage V_{d} can be replaced by the output voltage [symbol] to cancel the average retriever 4500 for simplifying the controller circuit. A phase shifter 2000 shifts the reference signal S(ωt) with the duty phase θ to obtain a phase-dependent signal S(ωt-θ), and a multiplier 5000 uses the phase-dependent signal S(ωt-θ) and the switching signal amplitude \hat{V}_{S}/V_{d} to obtain a switching control signal V_{cont}. And then, the switching control signal V_{cont} is sent to the inverting end of a comparator 3000, and a triangle waveform signal Vₜᵣᵢ, which is generated by a triangular signal generator 6000, is sent to the noninverting end of the comparator 300. Finally, the comparator 3000 produces a switching signal d(t).

It is noted that in the conventional design, the triangle waveform signal Vₜᵣᵢ is sent to the inverting end of the comparator 3000. Alternatively, in the invented control circuit, the switching control signal V_{cont} and the triangle waveform signal Vₜᵣᵢ generated by generator 6000 are sent to the inverting end and the noninverting end of the comparator, respectively, according to this invention. If the conventional design is employed, the switching control signal V_{cont} should be sent to an additional operator to obtain the signal (1-V_{cont}). Then, by sending the signal (1-V_{cont}) to the noninverting end of the comparator 3000, and sending the triangle signal Vₜᵣᵢ to the inverting end of the comparator 3000, the same switching signal d(t) can be obtained, but the overall circuit of the controller would be complicated.

Accordingly, the voltage circuit 1000 only uses the output voltage [symbol] of the converter to obtain the duty phase θ, and can be implemented by a simple proportional integration controller (PI) to achieve the function. Comparing the power factor correction method and controller of this invention with that in prior arts, this invention only uses a voltage control circuit to detect and receive the input voltage and output voltage of the converter, and this invention can be applied to the continuous conduction mode (CCM). More specially, in this invention, the current control circuit and the detection of the input current are not necessary, so that the circuit of the controller is simplified dramatically.

Although the present invention has been explained in relation to its preferred embodiment, it is to be understood that other modifications and variation can be made without departing the spirit and scope of the invention as claimed.

What is claimed is:

1. A power factor correction method, applied to a boost-type converter, comprising steps of:
producing a duty phase according to an output voltage of said boost-type converter and a voltage command;
producing a reference switching signal according to an input voltage of said boost-type converter;
producing a switching control signal by shifting said reference switching signal with said duty phase;
producing a triangle waveform signal; and
producing a switching signal by comparing said switching control signal with said triangle waveform signal.

2. The power factor correction method in claim 1, wherein the step of producing said duty phase is to calculate a difference between said output voltage and said voltage command, and then to produce said duty phase according to said difference.

3. The power factor correction method in claim 1, wherein the step of producing said reference switching signal is to divide said input voltage by said voltage command.

4. The power factor correction method in claim 1, wherein the step of producing said reference switching signal is to divide said input voltage by said output voltage.

5. The power factor correction method in claim 1, wherein the step of producing said reference switching signal is to divide said input voltage by the average voltage of said output voltage in a switching period.

6. A power factor controller, applied to a boost-type converter, comprising:
a voltage circuit, which receives an output voltage of said boost-type converter and a voltage command to output a duty phase;
a reference switching signal generator, which receives an input voltage of said boost-type converter to produce a reference switching signal;
a phase shifter, which receives said duty phase and said reference switching signal to produce a switching control signal;
a triangle wave generator, which generates a triangle waveform signal; and
a comparator, which compares said switching control signal with said triangle waveform signal to produce a switching signal.

7. The power factor controller in claim 6, wherein said voltage circuit is a proportional-integral controller.

8. The power factor controller in claim 6, wherein said reference switching signal generator comprises an absolute value retriever.

9. The power factor controller in claim 8, wherein said reference switching signal generator comprises a divider further.

10. A power factor controller, applied to a boost-type converter, comprising:
a voltage circuit, which receives an output voltage of said boost-type converter and a voltage command to output a duty phase;
a reference switching signal generator, which receives an input voltage and said output voltage of said boost-type converter to produce a reference signal and a switching signal amplitude;
a phase shifter, which receives said duty phase and said reference signal to produce a phase-dependent signal;
a multiplier, which receives said phase-dependent signal and said switching signal amplitude to produce a switching control signal;
a triangle wave generator, which generates a triangle waveform signal; and
a comparator, which compares said switching control signal with said triangle waveform signal to produce a switching signal.

11. The power factor controller in claim 10, wherein said voltage circuit is a proportional-integral controller.

12. The power factor controller in claim 10, wherein said reference switching signal generator comprises an absolute value retriever, a maximum retriever, a first divider, an average retriever and a second divider.
